(19) United States
(12) Patent Application Publication
(10) Pub. No.: US 2010/0245701 A1
(43) Pub. Date: Sep. 30, 2010

(54) MIRROR WITH MONITOR FOR VEHICLE

(75) Inventors: Hidenori SATO, Fujieda-city (JP); Masatoshi NAKAMURA, Fujieda-city (JP)

Correspondence Address: GREENBLUM & BERNSTEIN, P.L.C., 1950 ROLAND CLARKE PLACE, RESTON, VA, 20191, US

(73) Assignee: MURAKAMI CORPORATION, Shizuoka (JP)

(21) Appl. No.: 12/704,845

(22) Filed: Feb. 12, 2010

(30) Foreign Application Priority Data
Mar. 24, 2009 (JP) 2009-72371

(51) Int. Cl. G02F 1/1333; G02B 5/30; G02B 27/28

(52) U.S. Cl. 349/56; 359/486; 359/487

(57) ABSTRACT

To provide a mirror with a monitor for a vehicle that allows display light to pass through a region of a mirror surface thereof to be visually recognized by a viewer, in which the viewability of the display is improved while suppressing the cost increase. A region of a mirror element that transmits display light is formed of a wire grid having a polarization direction that agrees with the polarization direction of the display light. A region of the mirror element adjacent to the wire grid is formed of a reflective film formed of a reflective metal film or a dielectric multilayer film. The grid of the wire grid is formed of Al thin lines, for example. The reflective film is formed of a Cr half mirror, for example. A dark color mask is disposed on the back surface of the Cr half mirror.

The disclosure of Japanese Patent Application No. JP2009-72371 filed on Mar. 24, 2009 including the specification, drawings, claims and abstract is incorporated herein by reference in its entirety.

### BACKGROUND OF THE INVENTION

1. Field of the Invention

The present invention relates to a mirror with a monitor for a vehicle that allows display light to pass through a region of a mirror surface thereof from a back side of the mirror surface to be visually recognized by a driver or the like, in which the region that transmits the display light is improved to have an adequate reflectance when the monitor provides no display and to transmit an increased amount of display light compared with conventional to increase the viewability of the display when the monitor provides display, while suppressing the cost increase involved with the improvement.

2. Description of the Related Art

In Japanese Patent Laid-Open Nos. 3-28947U, 9-220976, and 2002-120649, there are described mirrors for a vehicle that display information on a light emitting display screen incorporated in the mirror at a position behind the mirror surface. The mirror for a vehicle described in Japanese Patent Laid-Open No. 3-28947U has a half mirror forming the mirror surface and a liquid crystal monitor incorporated at a position behind the half mirror. When the liquid crystal monitor is turned off (when the liquid crystal monitor provides no display), the entire mirror surface serves as a mirror. When the liquid crystal monitor is turned on (when the liquid crystal monitor provides display), the driver visually recognizes the display light transmitted through the half mirror. The mirror for a vehicle described in Japanese Patent Laid-Open No. 9-220976 has a half mirror forming the mirror surface and a fluorescent display tube incorporated at a position behind the half mirror. When the fluorescent display tube is turned off (when the fluorescent display tube provides no display), the entire mirror surface serves as a mirror. When the fluorescent display tube is turned on (when the fluorescent display tube provides display), the driver visually recognizes the display light transmitted through the half mirror. The mirror for a vehicle described in Japanese Patent Laid-Open No. 2002-120649 has a half mirror forming the mirror surface and a liquid crystal monitor or the like incorporated at a position behind the half mirror. In case that the rear window is bright, such as in the daytime, and in order to prevent the image displayed on the monitor from being obscured by the bright rear window reflected in the mirror when viewed from the driver's seat, the mirror for a vehicle is designed to change the angle of the mirror such that the rear window is not reflected in the mirror (i.e., to a darker direction) when the monitor is turned on.

### SUMMARY OF THE INVENTION

The mirrors for a vehicle described in Japanese Patent Laid-Open Nos. 3-28947U and 9-220976 have the problem pointed out in Japanese Patent Laid-Open No. 2002-120649. That is, when the rear window is bright, such as in the daytime, the image displayed on the monitor is obscured by the bright rear window which is reflected on the mirror, and thereby, it is difficult to view the image from the driver's seat. The viewability of the display can be improved by increasing the luminance of the display device. However, display devices capable of achieving higher luminance have problems that they tend to bigger and heavier and generate more heat. Alternatively, the amount of display light transmitted through the half mirror can be increased by lowering the reflectance of the half mirror. However, this approach has a problem that the half mirror cannot achieve adequate reflectance when the display device provides no display. Furthermore, the mirror for a vehicle described in Japanese Patent Laid-Open No. 2002-120649 needs a driving mechanism to change the angle of the mirror. In addition, the mirror has a problem that the mirror does not provide a view of the rear when the angle of the mirror is changed.

The present invention has been made in view of the circumstances described above, and an object of the present invention is to provide a mirror with a monitor for a vehicle that has a region that transmits display light, in which the region is improved to have an adequate reflectance when the monitor provides no display and to transmit an increased amount of display light compared with conventional to increase the viewability of the display when the monitor provides display, while suppressing the cost increase involved with the improvement.

The present invention provides a mirror with a monitor for a vehicle that allows linearly polarized display light emitted from a light emitting display device to pass through a region of the mirror surface from a back side of the mirror surface thereof to be visually recognized by a viewer, wherein the region of the mirror surface through which the display light passes is formed of a reflective polarizing film having a polarization direction that agrees with the polarization direction of the display light, and a region of the mirror surface adjacent to the reflective polarizing film is formed of a reflective film formed of a reflective metal film or a dielectric multilayer film. According to the present invention, since the region of the mirror surface that transmits the display light is formed of a reflective polarizing film having a polarization direction that agrees with the polarization direction of the display light, the amount of display light transmitted increases and the viewability of the display is improved compared with the case where the region of the mirror surface that transmits the display light is formed of a half mirror. In addition, since the region adjacent to the reflective polarizing film is formed of a reflective metal film or a dielectric multilayer film, the mirror can be manufactured at lower cost than the mirror having the entire mirror surface formed of the expensive reflective polarizing film. The reflective metal film can be a Cr, Ni, Al, Fe, Ag or Pd film, for example.

According to the present invention, the region of the mirror surface adjacent to the reflective polarizing film can be formed of a half mirror formed of a reflective metal film or a dielectric multilayer film, and a dark color mask can be disposed on a back surface of the half mirror. In this case, since the region of the mirror surface adjacent to the reflective polarizing film is formed of a half mirror formed of a reflective metal film or a dielectric multilayer film, and a dark color mask is disposed on a back surface of the half mirror, the reflective polarizing film and the adjacent region can have similar reflectance, and thus, the difference between the regions can be made inconspicuous when the monitor provides no display.

The reflective polarizing film used in the present invention can be a wire grid or a resin having an anisotropic refractive index (an anisotropic polarizing film), for example. However, a wire grid is preferably used as the reflective polarizing film according to the present invention, because the wire grid provides a clearer reflected image and therefore has a higher quality as a mirror when the monitor provides no display than the resin having an anisotropic refractive index. In the case where the reflective polarizing film is formed of a wire grid, the grid of the wire grid can be formed of Al thin lines, and the reflective film can be formed of a Cr half mirror, for example. In this case, the mirror surface region formed of the wire grid and the adjacent mirror surface region formed of the Cr half mirror have similar color when the monitor provides no display, and thus, the difference between the regions can be made further inconspicuous.

According to the present invention, the reflective film can be disposed (deposited or attached, for example) on a back surface of a transparent substrate, and the reflective polarizing film can be disposed on a region of the back surface of the transparent substrate where the reflective film is not disposed. In this case, since the reflective film is disposed on the back surface of the transparent substrate, the height difference between the reflective polarizing film and the surrounding reflective film can be made inconspicuous. In addition, the reflective polarizing film can be protected by the transparent substrate.

### BRIEF DESCRIPTION OF THE DRAWINGS

FIG. 1 is a cross-sectional view (illustration of a housing is omitted, and the thickness of each layer is schematically illustrated) taken along the line A-A in FIG. 2;

FIG. 2 is a front view of an inner mirror for a vehicle according to an embodiment of the present invention;

FIG. 3 is a graph showing spectral reflectance characteristics A and B of commercially available Al wire grids and spectral reflectance characteristics C, D and E of reflective films formed of half mirrors made of different kinds of metals having appropriate thicknesses to have characteristics approximate to the characteristics A and B;

FIG. 4 is a schematic cross-sectional view showing an exemplary arrangement of a wire grid 20 disposed on a back surface of a transparent substrate 24;

FIG. 5 is a schematic cross-sectional view showing another exemplary arrangement of the wire grid 20 disposed on the back surface of the transparent substrate 24; and

FIG. 6 is a cross-sectional view (illustration of the housing is omitted, and the thickness of each layer is schematically illustrated) taken along the line B-B in FIG. 2.

### DETAILED DESCRIPTION OF THE PREFERRED EMBODIMENTS

FIG. 2 is a diagram showing an inner mirror for a vehicle according to an embodiment of the present invention. In this embodiment described below, a reflective polarizing film is formed of a wire grid. An inner mirror 10 has a housing 12 and a mirror element 14 disposed in a front opening 12a of the housing 12. In a space in the housing 12 behind the mirror element 14, a liquid crystal monitor 16 is housed with a display surface 16a thereof facing the mirror element 14. A mirror surface of the mirror element 14 has a region 14a that faces the display surface 16a of the liquid crystal monitor 16 and a region 14b that surrounds the periphery of the region 14a. An operating element 18, such as an ON/OFF switch for the liquid crystal monitor 16, is disposed at a lower part of the front periphery of the housing 12. When the liquid crystal monitor 16 is turned on by manipulating the operating element 18, a backlight of the liquid crystal monitor 16 emits light to display information in the form of a text, an image, a video or the like. When the liquid crystal monitor 16 is turned off by manipulating the operating element 18, the backlight of the liquid crystal monitor 16 is turned off to stop information display, and the whole of the mirror surface regions 14a and 14b serves as a back mirror.

The region 14a of the mirror surface of the mirror element 14 facing the display surface 16a of the liquid crystal monitor 16 (that is, the region that transmits display light) is formed of a wire grid 20 having a polarization direction aligned with the polarization direction of the display light emitted from the display surface 16a of the liquid crystal monitor 16. The region 14b of the mirror surface of the mirror element 14 surrounding the wire grid 20 is formed of a reflective film 22 formed of a reflective metal film or a dielectric multilayer film. Wire grids are expensive, so that if the entire mirror surface of the mirror element 14 is formed of a wire grid, it would be too costly. However, since the region of the mirror element 14 other than the display part is formed of the reflective film 22 formed of a reflective metal film or a dielectric multilayer film, the cost can be reduced.

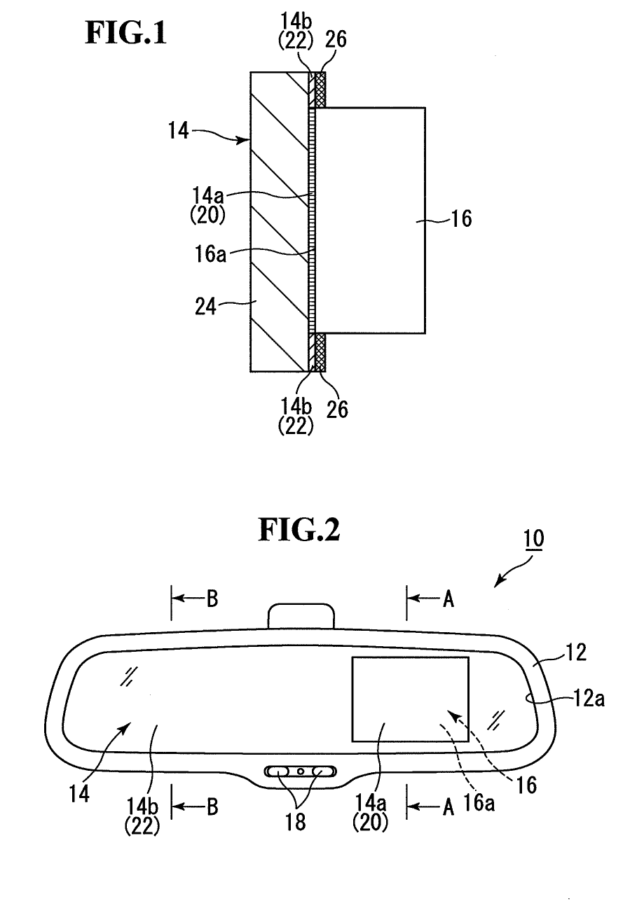

FIG. 1 shows a cross section (along the line A-A in FIG. 2) of a part of the inner mirror 10 where the liquid crystal monitor 16 is disposed (illustration of the housing 12 is omitted). In the entire region of this part, the mirror element 14 is formed by disposing the wire grid 20 on the back surface of a transparent substrate 24 made of glass or the like in the region 14a facing the display surface 16a of the liquid crystal monitor 16 and forming the reflective film 22 of a reflective metal film or a dielectric multilayer film deposited on the entire region 14b surrounding the wire grid 20 (that is, the entire mirror surface of the mirror element 14 excluding the region 14a in which the wire grid 20 is disposed). The wire grid 20 is attached to the back surface of the transparent substrate 24 or the display surface 16a of the liquid crystal monitor 16. To make the reflectance of the region 14a in which the wire grid 20 is disposed and the reflectance of the region 14b in which the reflective film 22 is disposed agree with each other, the reflective film 22 is formed of a half mirror, and a dark color mask 26 to prevent transmission of light is applied to the back surface of the reflective film 22. The dark color mask 26 consists of a plate, a film, a coating or the like having a dark color, such as black. In the case where the dark color mask 26 consists of a plate or a film, the dark color mask 26 is attached to the back surface of the reflective film 22 by using an adhesive or other gluing agent.

The wire grid 20 comprises a transparent substrate made of glass, a synthetic resin or the like and a grid made of thin lines of aluminum (Al thin lines) or the like formed on one surface of the transparent substrate.

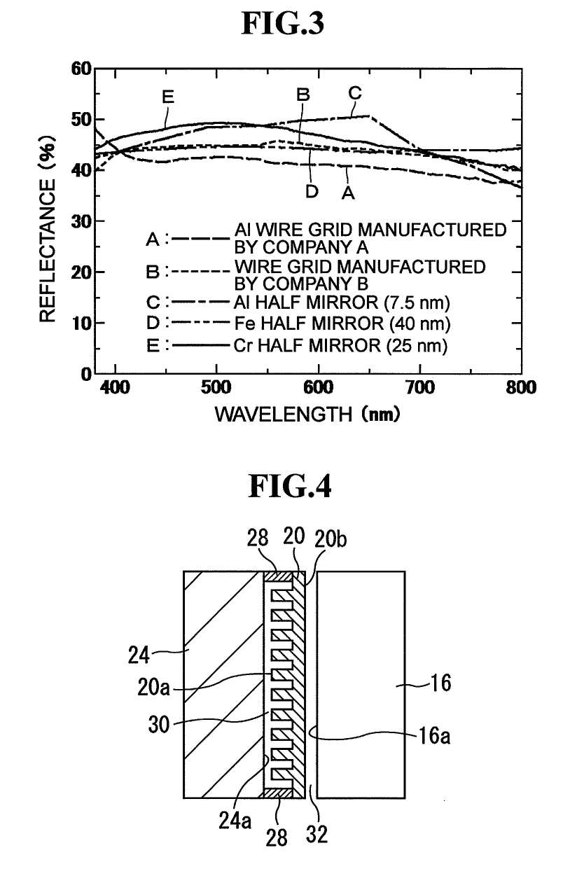

FIG. 3 shows exemplary spectral reflectance characteristics A and B of Al wire grids (wire grids formed using Al thin lines). The characteristic A is the characteristic of an Al wire grid manufactured by Company A, and the characteristic B is the characteristic of an Al wire grid manufactured by Company B. FIG. 3 also shows spectral reflectance characteristics C, D and E of reflective films 22 (half mirrors) made of different kinds of metals and having appropriate thicknesses to have characteristics approximate to those of the wire grids. The characteristic C is the characteristic of an Al half mirror (having a thickness of 7.5 nm), the characteristic D is the characteristic of a Fe half mirror (having a thickness of 40 nm), and the characteristic E is the characteristic of a Cr half mirror (having a thickness of 25 nm). As can be seen, the Al half mirror has a smaller thickness to have a reflectance that agrees with that of the Al wire grid. Therefore, variations in thickness have a great influence on the reflectance (even a slight variation in thickness has a great influence on the reflectance), and thus, it is difficult to control the thickness of the Al half mirror and to apply the Al half mirror to practical use. The Fe half mirror needs an adequate anti-corrosion treatment, and thus, it is difficult to apply the Fe half mirror to practical use. To the contrary, the Cr half mirror can have a larger thickness than the Al half mirror for the same reflectance, and thus, it is easy to control the thickness of the Cr half mirror and to match a color of the reflection light, and the Cr half mirror needs no, or only a simple, anti-corrosion treatment. Therefore, in the case where the wire grid 20 is formed of an Al wire grid, the reflective film 22 is preferably formed of a Cr half mirror.

FIG. 4 shows an exemplary arrangement of the wire grid 20 disposed on the back surface of the transparent substrate 24. A spacer 28 is attached to the back surface of the transparent substrate 24 along the entire periphery of the region 14a in which the wire grid 20 is disposed by an adhesive or the like, and the entire periphery of a front surface 20a (a surface on which the grid is formed) of the wire grid 20 is attached to the other end part of the spacer 28 by an adhesive or the like. The front surface (the surface on which the Al thin lines protrude) 20a of the wire grid 20 faces the back surface 24a of the transparent substrate 24 with a narrow gap 30 formed therebetween. The display surface 16a of the liquid crystal monitor 16 faces a back surface 20b of the wire grid 20 with a narrow gap 32 formed therebetween. The transparent substrate 24 is fitted into and held in the front opening 12a of the housing 12 (FIG. 2), and the liquid crystal monitor 16 is attached to and held on a wall defining an inner space of the housing 12. Since the gap 30 is narrow, the height difference between the front surface 20a of the wire grid 20 forming a reflecting surface and the surrounding reflective film 22 (FIG. 1) is not conspicuous.

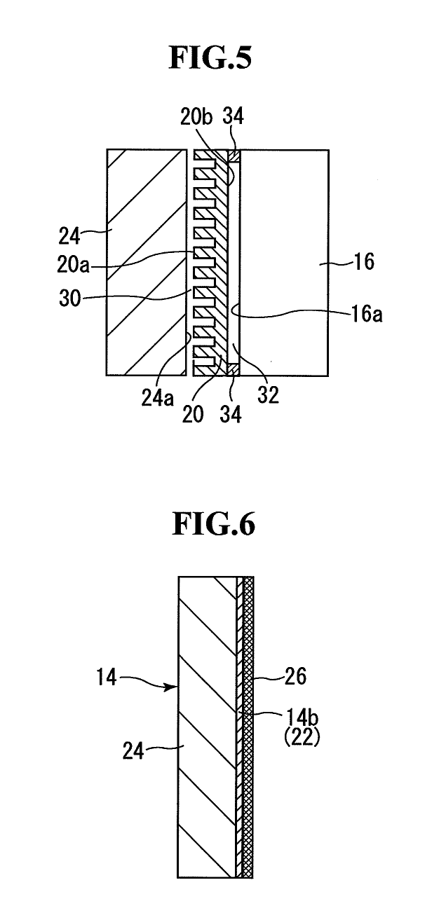

FIG. 5 shows another exemplary arrangement of the wire grid 20 disposed on the back surface of the transparent substrate 24. A spacer 34 is attached to the display surface 16a of the liquid crystal monitor 16 along the entire periphery of the display surface 16a by an adhesive or the like, and the entire periphery of the back surface 20b of the wire grid 20 is attached to the other end part of the spacer 34 by an adhesive or the like. The display surface 16a of the liquid crystal monitor 16 faces the back surface 20b of the wire grid 20 with a narrow gap 32 formed therebetween. The front surface 20a of the wire grid 20 faces the back surface 24a of the transparent substrate 24 with a narrow gap 30 formed therebetween. The transparent substrate 24 is fitted into and held in the front opening 12a of the housing 12 (FIG. 2), and the liquid crystal monitor 16 is attached to and held on a wall which forms an inner space of the housing 12. Since the gap 30 is narrow, the height difference between the front surface 20a of the wire grid 20 forming a reflecting surface and the surrounding reflective film 22 (FIG. 1) is not conspicuous.

FIG. 6 shows a cross section (along the line B-B in FIG. 2) of a part of the inner mirror 10 where the liquid crystal monitor 16 is not disposed (illustration of the housing 12 is omitted). In the entire region of this part, the mirror element 14 is formed by depositing the reflective film 22 formed of a half mirror on the back surface of the transparent substrate 24 and attaching the dark color mask 26 to the back surface of the reflective film 22.

An operation of the inner mirror configured as described above will be described. When the liquid crystal monitor 16 is turned on, the backlight of the liquid crystal monitor 16 emits light to display information in the form of a text, an image, a video or the like. The polarization direction of the display light agrees with the polarization direction of the wire grid 20, and therefore, the display light passes through the wire grid 20 and the transparent substrate 24 and visually recognized by a viewer, such as a driver, who is in front of the mirror surface of the mirror element 14. The amount of the display light transmitted is increased compared with the case where a half mirror formed of a metal film is used, and therefore, the viewability of the display is improved. Specifically, if the linearly polarized display light passes through a half mirror, the half mirror significantly attenuates the light. However, in this embodiment, the wire grid 20, which is arranged so that the polarization direction agrees with the polarization direction of the display light, is used, so that the display light is not significantly attenuated when the light passes through the wire grid 20.

When the liquid crystal monitor 16 is turned off, the backlight of the liquid crystal monitor 16 is turned off to stop information display. In this state, the region 14a where the wire grid 20 is disposed and the region 14b where the reflective film 22 is disposed have similar reflectance and color tone, and therefore, the difference between the regions 14a and 14b is not conspicuous. As a result, the driver can use the entire region of the mirror surface of the mirror element 14 as a back mirror without feeling uncomfortable.

In the embodiment described above, the reflective film 22 is formed of a reflective metal film. However, a dielectric multilayer film formed by alternately stacking a high refractive index layer, such a TiO₂ layer, and a low refractive index layer, such as a SiO₂ layer, may be used. Furthermore, in the embodiment described above, a reflective polarizing film is formed of a wire grid. Alternatively, however, a resin having an anisotropic refractive index may be used. Furthermore, in the embodiment described above, the present invention is applied to an inner mirror. However, the present invention can also be applied to an outer mirror or other mirrors for a vehicle.

What is claimed is:

1. A mirror with a monitor for a vehicle that allows linearly polarized display light emitted from a light emitting display device to pass through a region of the mirror surface from a back side of a mirror surface thereof to be visually recognized by a viewer,
wherein the region of the mirror surface through which the display light passes is formed of a reflective polarizing film having a polarization direction that agrees with the polarization direction of the display light, and
a region of the mirror surface adjacent to the reflective polarizing film is formed of a reflective film formed of a reflective metal film or a dielectric multilayer film.

2. The mirror with a monitor for a vehicle according to claim 1, wherein the region of the mirror surface adjacent to the reflective polarizing film is formed of a half mirror formed of a reflective metal film or a dielectric multilayer film, and
a dark color mask is disposed on a back surface of the half mirror.

3. The mirror with a monitor for a vehicle according to claim 1, wherein the reflective polarizing film is formed of a wire grid.

4. The mirror with a monitor for a vehicle according to claim 2, wherein the reflective polarizing film is formed of a wire grid.

5. The mirror with a monitor for a vehicle according to claim 3, wherein a grid of the wire grid is formed of Al thin lines, and the reflective film is formed of a Cr half mirror.

6. The mirror with a monitor for a vehicle according to claim 4, wherein a grid of the wire grid is formed of Al thin lines, and the reflective film is formed of a Cr half mirror.

7. The mirror with a monitor for a vehicle according to claim 1, wherein the reflective film is disposed on a back surface of a transparent substrate, and
the reflective polarizing film is disposed on a region of the back surface of the transparent substrate where the reflective film is not disposed.

8. The mirror with a monitor for a vehicle according to claim 2, wherein the reflective film is disposed on a back surface of a transparent substrate, and
the reflective polarizing film is disposed on a region of the back surface of the transparent substrate where the reflective film is not disposed.

9. The mirror with a monitor for a vehicle according to claim 3, wherein the reflective film is disposed on a back surface of a transparent substrate, and
the reflective polarizing film is disposed on a region of the back surface of the transparent substrate where the reflective film is not disposed.

10. The mirror with a monitor for a vehicle according to claim 4, wherein the reflective film is disposed on a back surface of a transparent substrate, and
the reflective polarizing film is disposed on a region of the back surface of the transparent substrate where the reflective film is not disposed.

11. The mirror with a monitor for a vehicle according to claim 5, wherein the reflective film is disposed on a back surface of a transparent substrate, and
the reflective polarizing film is disposed on a region of the back surface of the transparent substrate where the reflective film is not disposed.

12. The mirror with a monitor for a vehicle according to claim 6, wherein the reflective film is disposed on a back surface of a transparent substrate, and
the reflective polarizing film is disposed on a region of the back surface of the transparent substrate where the reflective film is not disposed.

13. The mirror with a monitor for a vehicle according to claim 7, wherein the reflective polarizing film is attached to the back surface of the transparent substrate or a display surface of the light emitting display device.

14. The mirror with a monitor for a vehicle according to claim 8, wherein the reflective polarizing film is attached to the back surface of the transparent substrate or a display surface of the light emitting display device.

15. The mirror with a monitor for a vehicle according to claim 9, wherein the reflective polarizing film is attached to the back surface of the transparent substrate or a display surface of the light emitting display device.

16. The mirror with a monitor for a vehicle according to claim 10, wherein the reflective polarizing film is attached to the back surface of the transparent substrate or a display surface of the light emitting display device.

17. The mirror with a monitor for a vehicle according to claim 11, wherein the reflective polarizing film is attached to the back surface of the transparent substrate or a display surface of the light emitting display device.

18. The mirror with a monitor for a vehicle according to claim 12, wherein the reflective polarizing film is attached to the back surface of the transparent substrate or a display surface of the light emitting display device.
